(19) United States
(12) Patent Application Publication
(10) Pub. No.: US 2007/0283641 A1
(43) Pub. Date: Dec. 13, 2007

(54) Valved Moisture Barrier

(76) Inventor: Vincent J. Cushing, Annapolis, MD (US)

Correspondence Address: SUGHRUE MION, PLLC, 2100 PENNSYLVANIA AVENUE, N.W., SUITE 800, WASHINGTON, DC, 20037, US

(21) Appl. No.: 10/595,659

(22) PCT Filed: Nov. 3, 2004
(86) PCT No.: PCT/US04/36488

§ 371 Date: Jun. 8, 2007

Related U.S. Application Data
(60) Provisional application No. 60/516,305, filed on Nov. 3, 2003.

(51) Int. Cl. E06B 7/14

(52) U.S. Cl. 52/209

(57) ABSTRACT

Moisture barriers are provided on both sides of an insulating enclosure together with switched vents/valves such that the enclosure is always vented, and possibly flushed, to the cool side. The number of valves used may depend on the volume to be vented and the speed with which venting is desired. In the case of an overall building envelope, the envelope is vulnerable to the dynamic pressure of winds and gusts, and the invention provides ventilating duct manifolds for each enclosure that utilize wind pressures to inhibit moisture transport from the living quarters to the building envelope and to flush moisture from the building envelope enclosure.

The present invention is based on and claims priority from U.S. Application No. 60/516,305 filed Nov. 3, 2003, the subject matter of which is incorporated by reference herein.

### BACKGROUND OF THE INVENTION

The present invention relates to insulated enclosures, particularly insulated glass windows and insulated buildings and other enclosures. The invention is particularly directed to the elimination or substantial reduction of condensation within the insulation envelope.

FIG. 1 illustrates an insulated glass window (IGW), showing the panes as the inside (LQ) and outside (OW) moisture barriers—with the insulating “interspace” containing air. The figure depicts a warm outside temperature and a cool inside temperature, with an intermediate temperature in the interspace sandwiched between the panes. Vapor pressure is uniform in the Interspace, equal to pₛ, owing to natural convection currents.

With the interspace insulation consisting of air, gravity convection sets up circulating air currents (the principal means of heat transmission through gaseous insulation). A conventional IGW uses air in the interspace, vented such that the air pressures (i.e., partial pressures of air constituents—nitrogen, oxygen, . . . ) are the same on the outside, the interspace, and the inside—to avoid stressing the panes. However, water vapor is the one air constituent where the partial pressures are not the same in the three regions. The inside (LQ) of the house is a source of moisture, owing to respiration, perspiration, cooking, etc.

For building insulation, it has long been recommended that a moisture barrier be placed on the warm side. The barrier is placed on the inside boundary of the insulation, since heating has historically been the major concern. Having the moisture barrier on the inside is technically equivalent to equalizing the vapor pressures on the outside and in the interspace. During the cooling season, when the warm outside humidity is high, condensation occurs on the cooler side of the moisture barrier, damaging the insulation and offering a bed for mold and germ infestation.

For heating season, Lstiburek (Lstiburek, Joseph W, Air Pressure and Building Envelopes, Building Science Corporation, Westford Mass.) pumps low-pressure/high-flowrate outside air into the building envelope and flushes via the cool outside conduit. The pressure in the building envelope is 5-10 Pa higher than in the living quarters—attempting to block moisture-laden leakage air flow from the living quarters into the building envelope. Also for heating season, Quirouette (Quirouette, Rick, Dynamic Buffer Zone Installation, Case Study Number 37, Canada Mortgage and Housing Corporation, Suite 1000, 700 Montreal Rd, Ottawa ON K1A0P7) reapplies 5-10 Pa of back pressure, together with flushing. Neither addresses condensation problems in the building envelope to accommodate both heating and cooling seasons.

### SUMMARY OF THE INVENTION

It is an object of the present invention to prevent condensation within the interspace of an insulated glass window, and to similarly prevent condensation within an insulated building envelope. The subject invention places the insulation within an interspace that is enveloped by a moisture barrier on both sides, and adds one or two leakage bypass valves, such that venting is always to the coolside. During heating season, temperature in the insulation is at least slightly higher than on the outside. Hence, by venting to the outside (i.e., moisture barrier on the inside) via a leakage valve, the temperature in the insulation does not fall to the dewpoint. During cooling season it is reversed: venting to the inside (i.e., moisture barrier on the outside) again provides humidity that cannot reach the dewpoint in the insulation.

The simplest implementation is a manual lever or knob on the leakage valve to switch between inside and outside venting. An automated implementation uses inside and outside temperature sensors such that the inside/outside differential temperature determines which side is vented.

Poor and degraded seals and barrier permeabilities become relatively unimportant. The coolside vent valves full open conductance need not be exceedingly high; rather it simply need be high compared to the flow conductance or breathing of the barriers (and seals).

For a building envelope the vent valves of FIG. 1 are solenoid operated. The HVAC control (e.g., a thermostat) actuates the vent valves—venting the interspace to the inside when cooling, and to the outside when heating.

The invention is applicable to insulated glass windows, where glass panes are the inside and outside moisture barriers and air in the interspace is the insulation. It is also applicable to a Building Envelope containing thermal insulation, with inside and outside moisture barriers.

### BRIEF DESCRIPTION OF THE DRAWINGS

The invention will be more clearly understood from the following description in conjunction with the accompanying drawings, in which:

FIG. 1 depicts in side section an insulated glass window (IGW);

FIG. 2 depicts a similar IGW in schematic form, with FIGS. 2(a)-2(c) illustrating suitable valving arrangements for implementing the invention;

FIG. 3 schematically shows an IGW having inside and outside moisture barriers with valves to vent the interspace to either inside or outside, whichever is cooler;

FIG. 4 shows an inside-outside bivalve, with a magnet to make the valve bistable;

FIG. 5 shows a pin bearing and differential temperature bimetal actuator which can be used to actuate the bivalve of FIG. 4, the actuator shown in its neutral position when differential temperature is zero;

FIG. 6 illustrates the valved moisture barrier concept applied more generally to a building envelope instead of a single IGW;

FIGS. 7(a)-(d) illustrate further building envelope configurations, with FIG. 7(a) showing a breathable inside moisture barrier and two outside vent valves, FIG. 7(b) illustrating a breathable inside moisture barrier and a single outside vent valve, FIG. 7(c) showing a breathable outside moisture barrier and a single inside vent valve, and FIG. 7(d) showing a breathable outside moisture barrier and having the interspace connected to an HVAC source of dehumidified air;

FIG. 8 schematically depicts a nonlinear ventilation duct for assisting in the explanation of the building envelope application of the invention;

FIG. 9 shows a quintuple vent complex for explaining the building envelope application of the invention.

FIG. 10 shows wind/gust velocities measured in Annapolis during March-May 2004, as well as the associated “dynamic head” q_{∞}, and

FIG. 11 shows the pressure p about the periphery of a circular cylinder when subjected to transverse flow.

### DETAILED DESCRIPTION OF THE INVENTION

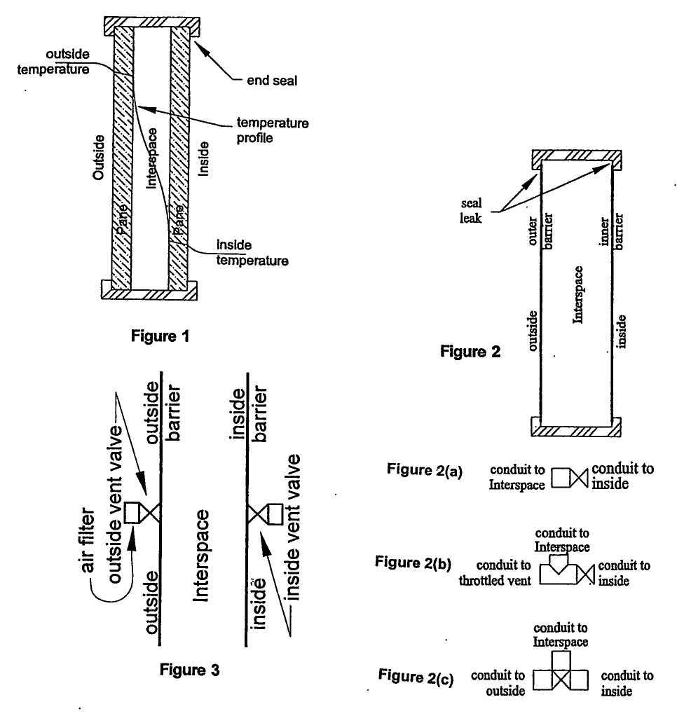

FIG. 1 illustrated an insulated glass window (IGW), and has already been described above.

FIG. 2 depicts a similar IGW, with FIGS. 2(a), (b) and (c) showing various valving arrangements that enable the interspace enclosure to be vented to the cool side.

FIG. 3 shows an IGW having inside and outside moisture barriers with valves to vent the interspace to either inside or outside, whichever is cooler. Air-with-vapor circulates in the interspace by thermal convection (rises on warm side, falls on cool). In the single open vent valve, vapor diffuses through air molecules, until vapor pressure equilibrates on both sides of vent valve.

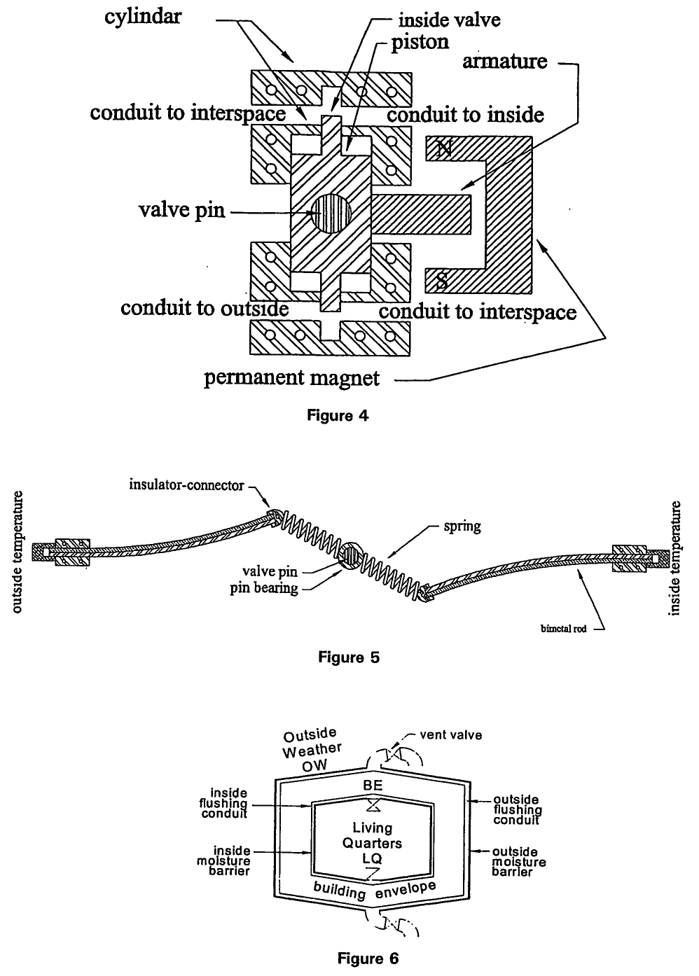

FIG. 4 shows an inside-outside bivalve, with a magnet structure to make the valve bistable. The only stable positions for armature are: (1) nearest to North pole; or, (2) nearest to South pole.

FIG. 5 illustrates a pin bearing and differential temperature bimetal valve actuator which can be used to actuate the bivalve of FIG. 4. The bivalve of FIG. 4 vents the interspace to the cooler side, using the differential temperature actuator of FIG. 5. The actuator is shown in FIG. 5 in its neutral position, when the differential temperature is zero.

FIG. 6 illustrates the valved moisture barrier concept applied more generally to a building envelope instead of a single IGW. The living quarters are enveloped in a building envelope separating the living quarters LQ from the outside weather OW. The envelope is defined by inside and outside moisture barriers, and can be vented to the inside or outside through vent valves and inside and outside flushing conduits as illustrated. The valves are controlled such that flushing substantially takes place in the conduit on the cool side.

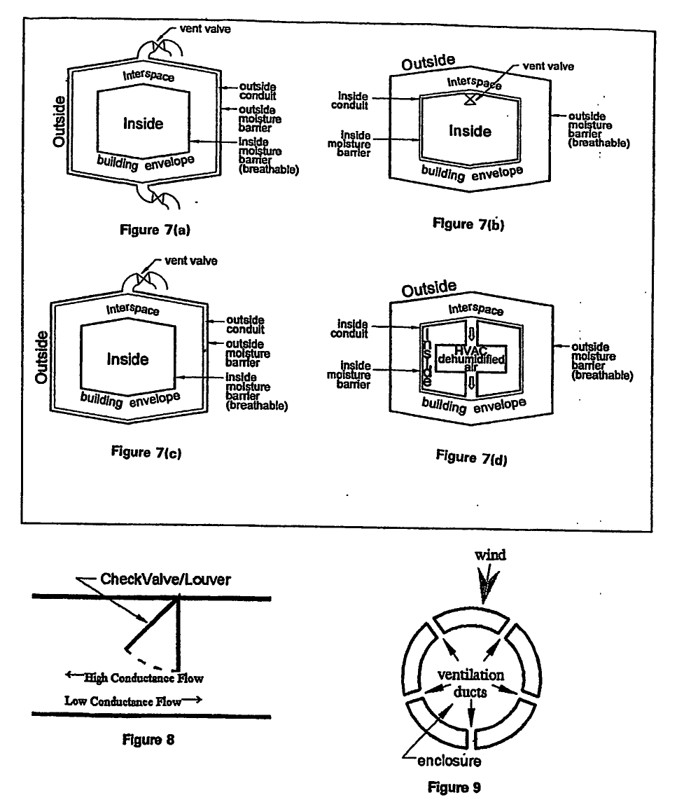

FIGS. 7(a)-(d) illustrate further building envelope configurations, with FIG. 7(a) showing a breathable inside moisture barrier and two outside vent valves, FIG. 7(b) illustrating a breathable inside moisture barrier and a single outside vent valve, FIG. 7(c) showing a breathable outside moisture barrier and a single inside vent valve, and FIG. 7(d) showing a breathable outside moisture barrier and having the interspace connected to an HVAC source of dehumidified air. Note that in those cases where one of the moisture barriers is breathable, it allows passage of air at a rate lower than the open vent, so that opening the vent will ventilate the interspace to the side communicating with the vent valve, and closing the valve will substantially ventilate the interspace to the side in contact with the breathable moisture barrier.

In FIGS. 6 and 7, the configurations with two vent valves per barrier permit flushing; while those with a single vent valve per barrier instead rely on diffusion through the vent valve.

As described earlier, it has been known to apply back pressure to the building envelope to prevent moisture-laden air from entering the building envelope from the living quarters. The present invention further addresses the issue of moisture-laden air entering the building envelope from the outside environment during times of high humidity. In addition, however, the present inventor provides a more effective way of determining how much back pressure is effective.

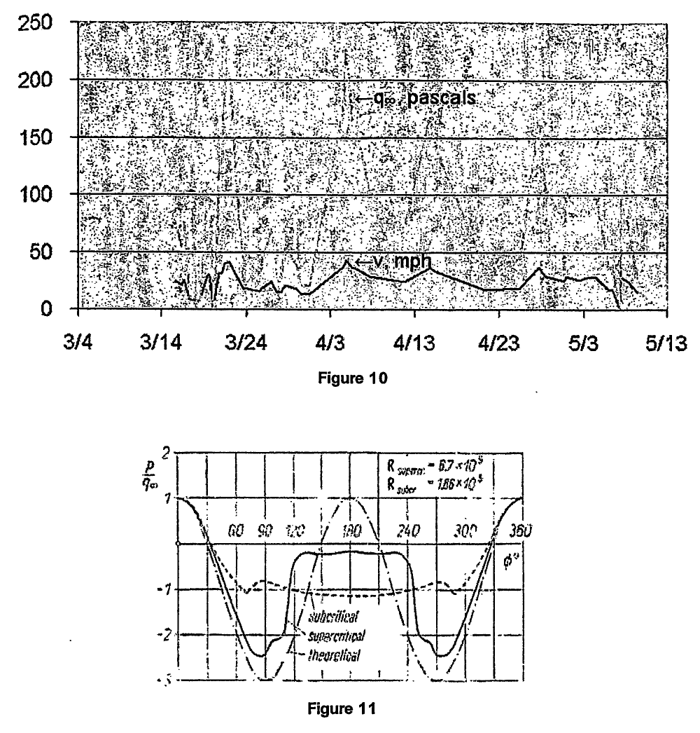

A wind blown enclosure (whether LQ or BE) is subject to wind and gust dynamic head (or dynamic pressure) q_{∞}
q_{∞}=½ρv². (1)
If q_{∞} is in pascals, then air density ρ is 1.229 kg/m³ SeaLevelStaticStandard (SLS), less at altitude, and v is the wind velocity in m/s. FIG. 10 shows wind/gust velocities measured in Annapolis during March-May 2004. The figure also shows the associated dynamic head q_{∞}.

Wind and gusts are owing to turbulence on a meteorologic scale. On a building scale, the winds and gusts are of long duration—such that flow patterns about the building have time to develop fully (i.e., are quasi-stationary). Dynamic head is additionally turbulent owing to air flow through a matrix of upstream urban structures.

To find how these dynamic pressures or heads find their way into the interior of a building, one needs to know the pressure distribution around the enclosure. The present inventor is unaware of any wind tunnel studies that provide this information for building-like shapes. Attention seems instead to have been concentrated on aerodynamic stresses on building shapes and on turbulence caused by building shapes.

To better understand what is involved, one can use available data—from the classical investigations of wind pressures on the periphery of a circular cylinder subjected to transverse flow. FIG. 11 shows the pressure p expressed as a multiple a(φ) (=p/q_{∞}) of dynamic head, as discussed by Schlichting (Schlichting, Hermann, Boundary Layer Theory, McGraw-Hill, New York, 1968, p21). Practically significant wind flows around buildings are supercritical.

The pressure within any building envelope depends on the location of the envelope's ventilation port. If a single port is upstream into the wind (azimuth φ=0° in a circular building), the interior gauge pressure is q_{∞} (the stagnation pressure), i.e., a(0°)=1, and the enclosure's internal pressure pᵢ=q_{∞}. If ventilated at about 85°, a(85°)≈−2.4. If ventilation is uniformly distributed around the cylinder's periphery, a is averaged around the entire periphery, i.e., a̅≈−¾ and pᵢ=−¾ q_{∞}.

When the valve is closed the duct has smaller flow conductance than when the valve is open. The same can be accomplished by paralleling an ordinary duct with a duct containing a full check valve.

FIG. 9 shows an enclosure having a quintuple ventilation matrix. The enclosure's internal pressure pᵢ depends on wind direction. If the ducts' flow conductances are equal, pᵢ is bounded by
−0.79≧pᵢ/q₂₆ ≧−0.90. (2)
If the ventilation ducts are positive (e.g., incorporate check valves or blowers such that duct outflow conductance is larger than inflow conductance; see FIG. 8), then
pᵢ< p̅= a̅q_{∞}. for positive ducting (3a)
Otherwise
pᵢ> p̅ for negative ducting (3b)
Worst case is the living quarters LQ vented at 0° and the building envelope BE vented at 85°. The pressure difference between LQ and BE that drives moist air from LQ into BE is then 3.4 q_{∞}!

FIG. 8 shows a nonlinear ventilation duct, i.e., a ventilation duct having a non-liner partial check valve. Flow conductance in one direction is larger than in the opposite direction. If the duct is installed such that outflow from the enclosure is larger than inflow conductance, we define it as a positive (nonlinear) conductance; otherwise as a negative conductance.

In general the pressures in the LQ and BE enclosures depend on where and how they are vented—an avenue needing further study. Additionally there are serious effects of dynamic head alternations owing to wind velocity variations. Here one must pay attention to the enclosure's ventilation time constant τ

$$τ = V / [ {p}_{o} {\sum }_{i = 1}^{N} {C}_{i} ] . \qquad ( 4 )$$

where V is the enclosure's volume, pₒ is ambient pressure (101.3 kPa SLS, less at altitude), and Cᵢ are the flow conductances of the N ventilation ports.

The time constant τ of the enclosure LQ is long (V is large; the Cᵢ are small to avoid drafts and uncomfortable variations in LQ pressure)—while the time constant τ for the enclosure BE is relatively short. That must be changed: to prevent moisture leakage transport, LQ and BE designs should have the same time constant τ.

As an example, suppose that q_{∞} (t) is a step change from 0 to q_{∞} and that there is a single vent at a(φ). Then the enclosure's internal pressure p(φ,t) is
p(φ,t)/q_{∞}=a(φ)[1−e^{-t/τ}]. (5)
If there is to be no pressure difference between the LQ and BE enclosures to drive moist air via leakage, we must seek [indeed, for any q_{∞} (t)]
τ_{LQ}=τ_{BE}. (6)
If the time constants don't match, then there will be an alternating Δp between LQ and BE. The time-average air convection (volumetric flowrate via leakage) between LQ and BE will presumably be zero. But while Δp is positive, LQ's highly moist air is convected into BE; when negative, BE's lowly moist air is convected back into LQ. LQ is a source of moisture (breathing, perspiration, cooking, . . . ). Alternating exterior pressure pumps moisture from LQ into BE—unless the time constants are closely matched.

Increasing τ_{BE} to match τ_{LQ} makes expansive flushing of BE more difficult (see below). But concomitantly, the need for expansive flushing is reduced when Δp is maintained at or near zero.

Because of practicable error in matching τ_{BE} and τ_{LQ}, it might be well to superpose Lstiburek's and Quirouette's back pressure of a few pascals—to forbid LQ→BE air convection owing to small Δp variation associated with mismatch.

For buildings (residential, commercial/industrial, skyscrapers) we need to know, for LQ and BE, where ventilation portals should be located, what should be the ventilation flow conductances, how to provide the right kind of BE flushing.

We have cited here data for two-dimensional flow transverse to a circular cylinder. We need data for three-dimensional flow past practical building shapes.

For conventional building insulation there is no need for a transparent moisture barrier. Further, convection currents within the interspace (or within the building envelope BE) are substantially reduced. To foster adequate convection or flushing it may be useful to: (1) use leakage valves at the top and bottom of the interspace to provide natural convection; or, (2) explicitly provide adequate convection circulation paths in the insulation.

As discussed above, providing a valved moisture barrier an insulated glass window or a building envelope is effective in reducing condensation within the envelope during both heating and cooling seasons. A Valved Moisture Barrier (VMB) is incorporated in a Building Envelope (BE) when the following conditions prevail:
1. The BE provides thermal insulation between Living Quarters (LQ) and Outside Weather (OW). Usually the BE contains other elements as well, e.g., building structure. There are two moisture barriers: one between BE and LQ; the other between BE and OW. Each moisture barrier is bypassed with at least one valved duct, and the valves are actuated such that BE is substantially ventilated to the cooler side. If flushing is needed, each barrier may have two or more valved ducts to enable either natural or forced convection.
2. LQ has HVAC such that it may be cooled or heated, depending on outside weather conditions.

As will be appreciated, the interspace within an insulated glass window is thermal insulation space between the LQ and OW, and is a small scale example of the VMB according to this invention. Its two transparent panes serve as moisture barriers. Its air-filled interspace provides thermal insulation. It incorporates valved ducts, with valves actuated such that the interspace (its BE) is substantially ventilated to the cooler side.

It will be further appreciated that the invention has been described herein by way of illustrative examples, but that variations of the disclosed examples could be implemented without departing from the scope of the invention as defined in the appended claims.

I claim:

1. A valved moisture barrier between first and second environments, said moisture barrier comprising first and second moisture barriers separated by an insulating space and separating said insulating space from said first and second environments, respectively, and bypass means for bypassing each of said first and second moisture barriers, at least one of the bypass means comprising at least one controllable vent actuated to cause said insulating space to be substantially vented to whichever of said first and second environments is cooler.

2. A valved moisture barrier as claimed in claim 1, wherein said controllable vent bypasses said first moisture barrier and said second moisture barrier is permeable to air at a rate less than a rate at which said controllable vent is capable of passing air when it is open.

3. A valved moisture barrier as claimed in claim 2, wherein said first environment is an interior space of a building and said second environment is outside of said building.

4. A valved moisture barrier as claimed in claim 2, wherein said second environment is an interior space of a building and said first environment is outside of said building.

5. A valved moisture barrier between first and second environments, said moisture barrier comprising first and second moisture barriers separated by an insulating space and separating said insulating space from said first and second environments, respectively, a first controllable vent communicating said insulating space with said first environment and a second controllable vent communicating said insulating space with said second environment.

6. A valved moisture barrier as claimed in claim 5, further comprising at least one valve actuator for opening each vent when the temperature in said insulating space is higher than in its respective environment.

7. A valved moisture barrier as claimed in claim 6, further comprising at least one valve actuator for opening said first controllable vent when the temperature in said second environment is higher than in said first environment and for opening said second controllable vent when the temperature in said first environment is higher than in said second environment.

8. A valved moisture barrier as claimed in claim 7, wherein said actuator comprises a differential temperature actuator.

9. A valved moisture barrier as claimed in claim 6, wherein at least one of said vents comprises a bistable leakage bivalve.

10. A valved moisture barrier as claimed in claim 9, further comprising a differential temperature actuator controlling said bivalve.

11. A valved moisture barrier between first and second environments, said moisture barrier comprising first and second moisture barriers separated by an insulating space and separating said insulating space from said first and second environments, respectively, said first moisture barrier being breathable to allow passage of air between said insulating space and said first environment, and a controllable vent communicating said insulating space with said second environment.

12. A valved moisture barrier as claimed in claim 11, further comprising a valve actuator for opening said vent when the temperature in said second environment is lower than the temperature in said first environment.

13. A valved moisture barrier as claimed in claim 11, further comprising a valve actuator for opening said vent when the temperature in said second environment is lower than the temperature in said insulating space.

14. A valved moisture barrier as claimed in claim 11, wherein said controllable vent is capable of passing air at a higher rate than said breathable first moisture barrier.

15. A valved moisture barrier between first and second environments, said moisture barrier comprising first and second moisture barriers separated by an insulating space and separating said insulating space from said first and second environments, respectively, said first moisture barrier being breathable to permit passage of air between said insulating space and said first environment, and a moisture removal system coupled to said insulating space.

16. A valved moisture barrier between first and second environments, said moisture barrier comprising first and second moisture barriers separated by an insulating space, and a vapor pressure control system for controlling vapor pressure in said insulating space.
